(19) United States
(12) Patent Application Publication
(10) Pub. No.: US 2003/0140659 A1
(43) Pub. Date: Jul. 31, 2003

(54) Method for producing an optical fibre and blank for an optical fibre

(76) Inventor: Heinz Fabian, Grossostheim (DE)

Correspondence Address: TIAJOLOFF & KELLY, CHRYSLER BUILDING, 37TH FLOOR, 405 LEXINGTON AVENUE, NEW YORK, NY, 10174, US

(21) Appl. No.: 10/296,089

(22) PCT Filed: May 21, 2001
(86) PCT No.: PCT/EP01/05771

(30) Foreign Application Priority Data
May 24, 2000 (DE) 100 25 176.5

(51) Int. Cl. C03B 37/028

(52) U.S. Cl. 65/412

(57) ABSTRACT

In a known procedure for the manufacture of an optical fiber by drawing from a preform with a core-clad structure or from a coaxial arrangement of several components forming a core-clad structure, a core cylinder is produced with a soot deposition method, with the core cylinder having a core glass layer of a higher refractive index, “n_{K}”, and outer diameter, “d_{K}”, said core glass layer being encased by a first cladding glass layer having a lower refractive index, “n_{M1}”, and outer diameter, “d_{M1}”, followed by applying a second cladding glass layer onto the core cylinder. The modification of this procedure according to the invention is characterized by its lower optical fiber production costs. This is achieved by providing the second cladding glass layer (4) in the form of a cladding tube manufactured in a separate step of the procedure, said cladding tube having a mean OH concentration of max. 1 wt.-ppm, and applying the second cladding glass layer (4) by collapsing the cladding tube onto the core cylinder (2; 3), and by using a core cylinder with a “d_{M1}”/“d_{K}” ratio between 1 and 2.2 and a mean OH concentration of max. 1 wt-ppm in its superficial area up to a depth of 10 μm (FIG. 1).

The present invention relates to a procedure for the manufacture of an optical fiber by drawing from a preform with a core-clad structure or from a coaxial arrangement of several components forming a core-clad structure, in which a core cylinder is produced with a soot deposition method, said core cylinder having a core glass layer of a higher refractive index, “n_{K}”, and outer diameter, “d_{K}”, surrounded by a first cladding glass layer of a lower refractive index, “n_{M1}”, and outer diameter, “d_{M1}”, followed by applying a second cladding glass layer onto the core cylinder.

Furthermore, the invention relates to a preform for the manufacture of an optical fiber with a core glass layer of a higher refractive index, “n_{K}”, and outer diameter, “d_{K}”, which is coaxially surrounded by a first cladding glass layer of a lower refractive index, “n_{M1}”, and outer diameter, “d_{M1}” as well as a second cladding glass layer.

The use of optical fibers for data transmission has gained in economic importance over the past 20 years. While the improvement of the optical attenuation properties and physical strength of the fibers had been the focus early on, meanwhile cost reduction has become the main issue. Possible approaches concentrate on the increase of transmission capacity of each optical fiber and reduction of the manufacturing costs of optical fibers. The majority of the so-called single-mode optical fiber preforms for commercial applications are manufactured with one of the following known methods: outside vapor deposition (OVD), modified chemical vapor deposition (MCVD), plasma chemical vapor deposition (PCVD), and vapor axial deposition (VAD). These methods agree in that a core cylinder comprising the core and a part of the cladding of the finished single-mode optical fiber is manufactured first. Subsequently, additional quartz glass—the co-called “jacket material”—is applied to the core cylinder. The quality of said jacket material is of importance for the optical fiber's mechanical strength while its influence on the optical properties has been less significant.

A method and a preform of the type described above are known from U.S. Pat. No. 5,838,866 which describes the manufacture of a quartz glass preform for a single-mode optical fiber with the first step of the procedure being the manufacture by the so-called OVD method of a component possessing a core-clad structure that is termed, “core preform”. The core preform consists of a germanium dioxide-doped SiO₂ core glass layer enveloped by an inner SiO₂ cladding glass layer. The thickness of the different layers is designed such that, upon collapse of the inside bore hole, the ratio of diameter “d_{K}” of the core glass layer and outer diameter “d_{M1}” of the first cladding glass layer equals 2.39. The final preform is obtained by deposition of another SiO₂ soot layer forming a second, outside jacket glass layer.

The part of the cladding which faces the core preform and is directly adjacent to the core glass layer shall be designated hereinafter as “first cladding glass layer”. The first cladding glass layer makes an essential contribution to the optical transmission and thus has a definite influence on the optical properties of the optical fiber. Consequently, the requirements with respect to the purity and homogeneity of the first cladding glass layer must be comparable to the requirements met by the core glass layer; for this reason, the manufacture of the first cladding glass layer is rather resource-intensive and expensive.

In the known method, an oxyhydrogen gas burner is used for deposition of the SiO₂ soot layer on the core cylinder to form the second cladding glass layer. This procedure leads to the incorporation of OH groups into the first cladding glass layer. These OH groups are firmly bound within the quartz glass of the first cladding glass layer and cannot be removed by subsequent treatment of the soot layer in a chlorine atmosphere. Thus, the preform manufactured according to the known method usually is characterized by a significantly higher concentration of OH groups at the interface between the first and the second cladding glass layer.

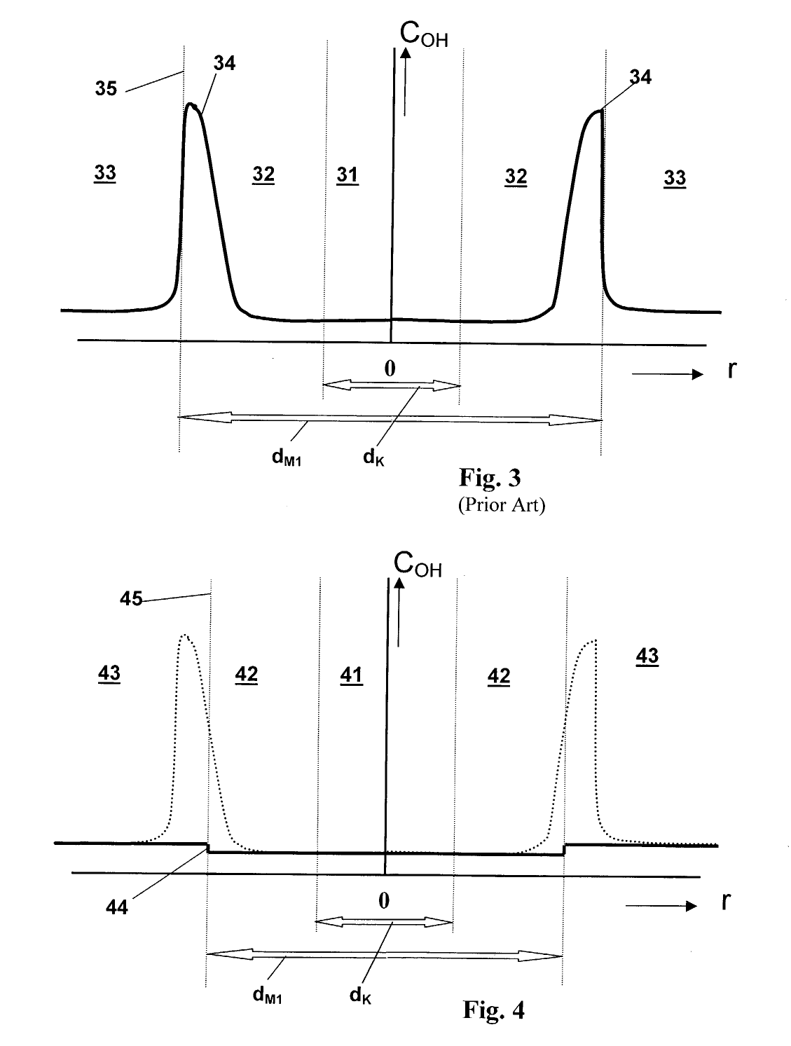

A typical OH concentration profile across the diameter of a preform manufactured according to the known OVD method is shown schematically in FIG. 3. The OH concentration is plotted along the diagram's Y-axis, and the preform diameter is plotted along the X-axis. Core glass layer 31 and the inner area of first cladding glass layer 32 show a low OH content. The area of interface 35 between first cladding glass layer 32 and second cladding glass layer 33 is characterized by the marked peak 34 of the OH concentration.

OH groups have a particularly strong absorption band in the infrared part of the spectrum. Thus, even low OH concentrations present in the optical transmission area of a single-mode fiber can affect the optical attenuation properties at the standard transmission wavelengths. In order to keep the effect of peak 34 of the OH concentration shown in FIG. 3 on the optical attenuation low, known OVD-preforms have interface 35 between first cladding glass layer 32 and second cladding glass layer 33 arranged distant from core glass layer 31, i.e. outer diameter “d_{M1}” of first cladding glass layer 32 is made relatively large: outer diameter “d_{M1}” of first cladding glass layer 32 of the preform shown in FIG. 3 is 2.39 times larger than diameter “d_{K}” of core glass layer 31.

Upon reduction of outer diameter “d_{M1}” of first cladding glass layer 32, peak 34 of the OH concentration would be closer to core glass layer 31 and thus have a more pronounced effect on the fiber's attenuation properties For this reason, it is not feasible in the existing method to reduce the size of inside cladding glass layer 32 of the preform, which is resource-intensive to produce, without concomitantly increasing optical attenuation.

The invention is thus based on the task of specifying an inexpensive method for the manufacture of an optical fiber with low optical attenuation and of providing a corresponding preform.

In terms of the procedure, this task is solved in the invention on the basis of the afore-mentioned procedure by providing the second cladding glass layer in the form of a cladding tube manufactured in a separate step of the procedure, said cladding tube having a mean OH concentration of max. 1 wt.-ppm and being applied to the core cylinder by collapsing, and by using a core cylinder with a “d_{M1}”/“d_{K}” ratio between 1 and 2.2 and a mean OH concentration of max. 1 wt-ppm in its superficial area up to a depth of 10 μm.

According to the invention, the second cladding glass layer is provided in the form of a cladding tube manufactured in a separate step of the procedure. A cladding tube of said type can be inexpensively manufactured with the common OVD soot deposition procedure by flame hydrolysis of a silicon-containing starting compound. The OH content of the cladding tube can be reduced and adjusted to 1 wt-ppm or less by any of the known dehydration procedures. The optical attenuation due to the presence of hydroxyl groups (OH groups) is less, the lower the mean OH concentration of the cladding tube is—especially at the inner bore hole of the tube. Usually, the OH concentration is constant across the cross-section of the cladding tube wall such that the mean OH concentration is easy to determine as it is equal to this value. In the presence of a non-constant OH concentration profile, the mean OH concentration is defined as the mean of the OH concentration across the cross-section of the cladding tube wall. The mean OH concentration is particularly easy to determine by spectroscopic means.

The second cladding glass layer is applied by collapsing the cladding tube onto the core cylinder. This procedure avoids exposing the first cladding glass layer to a hydrogen-containing gas and ensuing incorporation of hydroxyl groups into the quartz glass of the first cladding glass layer. Only small amounts of hydroxyl groups, if any, are produced while the cladding tube is collapsed onto the substrate.

The core cylinder to be provided according to the invention may be designed as a rod or tube. For reasons of simplicity, the explanations provided in the following shall refer to a rod-shaped core cylinder but by no means exclude a tube-shaped core cylinder unless stated otherwise.

The mean OH content of the superficial layer of the first cladding glass layer of the core cylinder up to a depth of 10 μm is max. 1 wt-ppm. Generating the second cladding glass layer by collapsing a cladding tube onto the core cylinder has no or only an insignificant effect on the OH concentration of the first cladding glass layer. The mean OH concentration of the superficial layer up to a depth of 10 μm can be determined by means of a spectroscopic difference measurement.

An essential factor contributing to the solution of the technical task stated above is that a core cylinder with a diameter ratio, “d_{M1}”/“d_{K}”, being more than 1 and less than 2.2 is employed in the procedure. Thus, outer diameter “d_{M1}” of the first cladding glass layer is smaller than the 2.2-fold of diameter “d_{K}” of the core glass layer. The diameter ratio, “d_{M1}”/“d_{K}”, refers to a core cylinder with no inner bore hole. For a tube-shaped core cylinder, the diameters of the respective layers after collapsing are to be applied.

Compared to the known optical fiber described above the volume fraction of the first cladding glass layer, which is very resource-consuming to manufacture, is reduced to the benefit of the other cladding material, which is much less cost-intensive to manufacture. This reduction is made possible only by combining the measures described above as each of these contributes to keeping the OH concentration at the interface between the first and second cladding glass layers of a core cylinder manufactured with the soot deposition procedure at a value of max. 1 wt-ppm. The low OH content near the interface is the essential factor allowing the outer diameter of the first cladding glass layer to be reduced to the extent that a diameter ratio, “d_{M1}”/“d_{K}”, between 1 and 2.2 can be established without the OH concentration of the area close to the interface exerting a significant effect on the optical attenuation properties of the fiber.

Consequently, the procedure according to the invention facilitates inexpensive manufacture of an optical fiber with low optical attenuation using the soot deposition procedure.

As one example, the fiber can be drawn from a preform with a core-clad structure in which the core cylinder of the preform is surrounded by the cladding tube and any additional jacket material. Alternatively, it is feasible to draw the fiber from a coaxial arrangement of several components forming a core-clad structure. In this design, the core cylinder is positioned inside the cladding tube and any additional jacket material in a coaxial arrangement. Both, the jacket material and the cladding tube are collapsed onto the core cylinder during the drawing process.

The present invention exclusively relates to the manufacture of standard single-mode fibers and a preform for said fibers. Standard single-mode fibers are simple step index fibers. The light wave is transmitted mainly through the core area and inner cladding area of the fibers. With the present invention it becomes feasible to reduce the fraction of high quality quartz glass required for the inner cladding area to the benefit of cheaper quartz glass qualtities. However, the present invention does not relate to the so-called “dispersion-shifted fibers” or “dispersion-smoothed fibers”. Fibers of these types are characterized by complex refractive index profiles as they consist of a sequence of several layers with different refractive indices. All of these layers contribute to light transmission and, consequently, these layers need to be made of high quality quartz glass which volume fraction of which cannot be reduced to the benefit of cheaper quartz glass qualities.

The influence of the OH content on optical attenuation decreases with decreasing OH concentration in the superficial area of the core cylinder and cladding tube. It has proven particularly favorable to use a cladding tube with a mean OH concentration of max. 0.5 wt-ppm and a core cylinder with a mean OH concentration of 0.5 wt-ppm in its superficial area up to a depth of 10 μm. Preferably, the OH content of both the cladding tube and superficial area of the core cylinder is kept at max. 0.2 wt-ppm; an OH concentration of max. 0.1 wt-ppm is especially preferred.

It is a feature of the present invention that the fraction of the total volume of the optical fiber made up by the first cladding glass layer, which is resource-consuming to manufacture, is reduced to the benefit of cheaper cladding material. The amount of cladding material replaced by cheaper material increases with decreasing core cylinder diameter ratio, “d_{M1}”/“d_{K}”. It has proven particularly favorable to use a core cylinder with a diameter ratio, “d_{M1}”/“d_{K}”, of less than 2.0, and preferably of less than 1.7.

The preform or the coaxial arrangement of components forming a core-clad structure is manufactured from a quartz glass cladding tube or a porous cladding tube consisting of SiO₂ soot. The use of a quartz glass cladding tube facilitates formation of an interference-free interface between the first and the second cladding glass layer, which has a positive effect on the optical attenuation properties of the fiber. In contrast, the use of an SiO₂ soot cladding tube is cheaper by comparison because the cladding tube becomes vitrified while it is collapsed onto the core cylinder which dispenses with the need for a separate heat treatment step for vitrification of the cladding tube.

It has proven especially favorable to use a cladding tube with a refractive index, “n_{M2}”, with “n_{M2}”≦“n_{M1}”. The transmission of light through the fiber is affected little by the second cladding glass layer, if refractive index “n_{M2}” is equal to “n_{M1}”, whereas the fraction of light transmitted by the second cladding glass layer is further reduced, if refractive index “n_{M2}”<“n_{M1}”, which means that lower requirements have to be met by the optical properties of the quartz glass used for this layer. This simplifies manufacture of the quartz glass for the second cladding glass layer and reduces manufacturing costs.

he use of a fluoride-doped cladding tube has proven particularly favorable. Fluoride-doping can be used to reduce the refractive index of quartz glass, i.e. the refractive index relationship of “n_{M2}”<“n_{M1}” is particularly easy and inexpensive to establish by using a fluoride-doped cladding tube.

It is advantageous to surround the second cladding glass layer with at least one additional, third cladding glass layer. This or these additional third cladding glass layer(s) provide additional quartz glass material for formation of the jacket. Jacketing the arrangement with a third cladding glass layer can result in the production of a preform from which an optical fiber can be drawn. Alternatively, the third cladding glass layer can be provided in the form of a quartz glass tube in coaxial arrangement to the core cylinder from which the fiber can be directly drawn.

In a first preferred variant of the procedure, the third cladding glass layer is provided in the form of a quartz glass hollow cylinder, which is then collapsed onto the core cylinder jointly with the cladding tube. This procedure is associated with lower costs because it allows to collapse several tubes onto the core cylinder in the same step.

In an alternative, but also preferred variant of the procedure the third cladding glass layer is provided in the form of a hollow cylinder made from porous SiO₂ soot, and shrunk onto the cladding tube after the cladding tube is collapsed onto the core cylinder. This variant of the procedure also has some advantages with respect to the manufacturing costs, because the porous SiO₂ soot hollow cylinder vitrifies while it is shrunk onto the cladding tube. Thus, there is no need for a separate vitrification step for the part of the jacket provided in the form of a SiO₂ soot hollow cylinder.

An additional, also suitable, variant of the procedure has the third cladding glass layer generated by outside deposition of SiO₂ soot after collapsing the cladding tube onto the core cylinder. This third cladding glass layer is subsequently vitrified. This variant of the procedure also has some advantages with respect to the manufacturing costs, because there is no need to separately manufacture a tube for the third cladding glass layer.

Especially because of the lower manufacturing costs, another variant of the procedure has proven advantageous, in which the second cladding glass layer is generated by providing a cladding tube with an outside coat of porous SiO₂ soot, which is then collapsed onto the core cylinder. In this variant, the core cylinder is jacketed by the second cladding glass layer and jacketing material in a common step of the procedure since the porous SiO₂ soot layer vitrifies while the cladding tube is collapsed onto the core cylinder.

Any additional third cladding glass layers have no significant influence on the light transmission properties of the fiber. As a consequence, the requirements on the optical properties of the material used for the third cladding glass layer are comparatively low. This renders the production of this quartz glass quite inexpensive. For this reason, the second cladding glass layer is designed to be as thin as possible, but also as thick as necessary. For this purpose, it has proven favorable to use a cladding tube which, after collapsing, generates a cladding glass layer with an outer diameter/inner diameter ratio of no less than 1.2, and preferably of no less than 1.8. Preferably, the outer diameter/inner diameter ratio of the cladding glass layer should not exceed a value of 3. The ratio of outer and inner diameter of the cladding glass layer refers to a core cylinder with no inner bore hole. For a tube-shaped core cylinder, the outer and inner diameters of the cladding glass layer after collapse of the inner bore hole are to be applied to determine said ratio of diameters.

Preferably, the outer diameter of the core cylinder and the inner diameter of the cladding tube are chosen such that upon collapsing of the cladding tube onto the core cylinder a coaxial arrangement with an annular gap is formed without hydrogen-containing substances being incorporated into the annular gap during the collapsing process. The exclusion of hydrogen-containing substances from the annular gap is a means of preventing the formation of hydroxyl groups in the walls in the vicinity of the annular gap. Preferably, this is achieved by generating negative pressure within the annular gap and/or filling the annular gap with helium, chlorine, fluorine or a mixture of these gases. Preferably, this is facilitated by continual rinsing of the annular gap with said gases.

In a preferred variant of the procedure of the invention, the core cylinder is manufactured with the outside vapor deposition method (OVD). The OVD method is particularly suitable for simple and inexpensive production of a core cylinder with a low diameter ratio, “d_{M1}”/“d_{K}”.

With respect to the preform, the task stated above is solved in the invention based on the preform described above by designing the second cladding glass layer in the form of a cladding tube, which is manufactured in a separate procedural step and subsequently collapsed onto the first cladding glass layer, and has a mean OH concentration of max. 1 wt-ppm; the area near the interface between the first and the second cladding glass layer extending up to 10 μm towards the core glass layer in a radial direction also has a max. OH concentration of 1 wt-ppm and the ratio, “d_{M1}”/“d_{K}”, being more than 1 and less than 2.2.

According to the invention, the second cladding glass layer is provided in the form of a cladding tube manufactured in a separate step of the procedure and subsequently collapsed onto the first cladding glass layer. A cladding tube of this type is inexpensive to manufacture by any of the common OVD soot deposition procedures using flame hydrolysis of a silicon-containing starting compound. The OH concentration of the porous soot cladding tube can be reduced and adjusted to a preset value of 1 wt-ppm or less by any of the known dehydration procedures. For a definition of “mean OH concentration” please refer to the section above explaining the procedure according to the invention.

Since the second cladding glass layer is generated by collapsing the cladding tube, the incorporation of hydroxyl groups into the quartz glass of the first cladding glass layer is largely prevented. As a consequence, the concentration of hydroxyl groups is low in the area of the first cladding glass layer near the interface between the first and the second cladding glass layer. The “area of the first cladding glass layer near the interface” shall be defined as an area with a radial extension of 10 μm in the direction of the core glass layer. The mean OH concentration of the area near the interface can be determined by means of a spectroscopic difference measurement.

An essential factor contributing to the solution of the technical task stated above is that the diameter ratio, “d_{M1}”/“d_{K}” is between 1 and 2.2. Thus, outer diameter “d_{M1}” of the first cladding glass layer is less than the 2.2-fold of diameter “d_{K}” of the core glass layer. Compared to the known preform described above, the volume fraction of the first cladding glass layer, which is rather resource-consuming to manufacture, is reduced to the benefit of the other jacket material, which is much less cost-intensive to manufacture. This reduction of the first cladding glass layer is made possible only by keeping the OH concentration at the interface between first and second cladding glass layer at a value of max. 1 wt-ppm. The low OH content near the interface is the essential factor allowing the outer diameter of the first cladding glass layer to be reduced to the extent that a diameter ratio, “d_{M1}”/“d_{K}”, between 1 and 2.2 can be established without the OH concentration of the area near the interface exerting a significant effect on the optical attenuation properties of the fiber.

Consequently, the preform according to the invention is inexpensive to manufacture with the soot deposition procedure.

Advantageous developments of the preform according to the invention are described in the subordinate claims. Since the subordinate claims correspond to claims of the procedure described above, please refer to the respective explanations above.

In the following, the invention is illustrated by means of embodiments and one drawing. It is shown in diagrammatic view in the drawing:

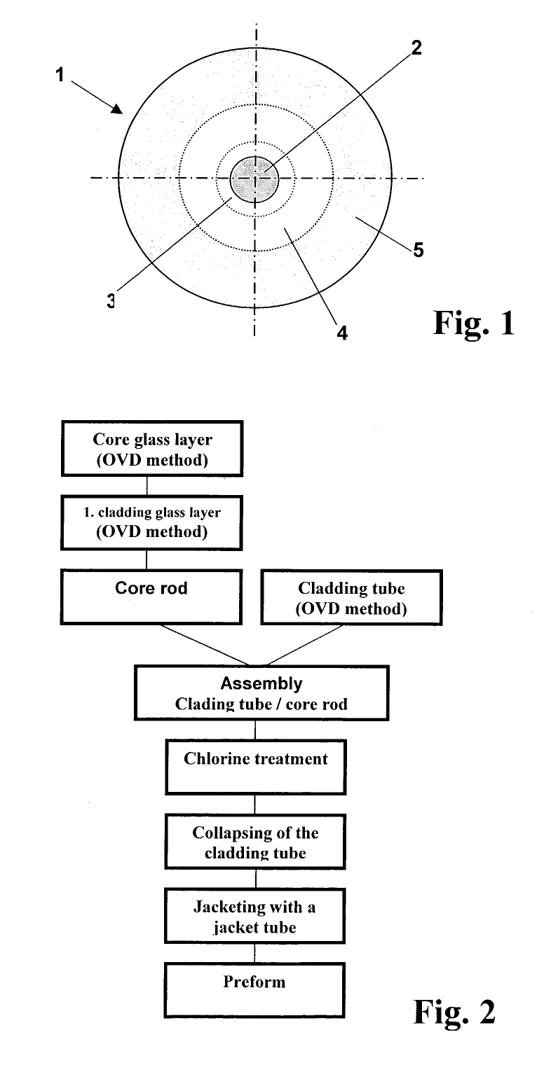

FIG. 1 a radial section of an embodiment of the preform according to the invention for manufacture of a single-mode fiber;

FIG. 2 an embodiment for manufacture of a preform according to the invention as a flow diagram including individual steps of the procedure;

FIG. 3 a section of the typical OH concentration profile across the diameter of a preform manufactured according to the state-of-the-art; and

FIG. 4 a section of the typical OH concentration profile across the diameter of a preform manufactured according to the invention.

Reference number, 1, in FIG. 1 is assigned to the whole of the preform according to the invention. Preform 1 consists of core glass zone 2, first cladding glass layer 3, second cladding glass layer 4, and jacket glass layer 5.

Core glass zone 2 is made of quartz glass homogeneously doped with 5 wt-% germanium dioxide. Core glass zone 2 has a diameter “d_{K}”=7 mm. The outer diameter, “d_{M1}”, of first cladding glass layer 3 is 13.9 mm. Thus, the diameter ratio, “d_{M1}”/“d_{K}”, is 1.99.

For manufacture of preform 1, core glass zone 2 and first cladding glass layer 3 are provided as a core rod onto which second cladding glass layer 4, provided in the form of a cladding tube, is collapsed. Second glass layer 4 consists of quartz glass with no doping agent added. In the embodiment shown, the outer diameter of second cladding glass layer 4 is 26.8 mm. Thus, the ratio of outer to inner diameter of second cladding glass layer 4 is 1.9. This ratio is somewhat lower in the original cladding tube from which second cladding glass layer 4 is generated, and depends on the width of the gap between cladding tube and core rod prior to the process of collapsing.

Second cladding glass layer 4 is surrounded by a so-called “jacketing tube” which forms an additional, jacket glass layer 5 and accounts for the largest part of the volume of preform 1.

In the following, the procedure according to the invention for manufacture of an optical fiber is illustrated using FIGS. 1 and 2 as examples.

As a prerequisite of the procedure according to the invention, a so-called core rod is generated by a soot deposition procedure (OVD method) involving flame hydrolysis of SiCl₄ and/or GeCl₄, in the course of which oxide particles are deposited on the envelope of a mandrel rotating around its longitudinal axis. An aluminium oxide tube with a diameter of 5 mm is employed as the mandrel. In the procedure, a deposition burner is used to initially deposit core glass zone 2. In addition to SiCl₄, GeCl₄ is fed to the burner to establish within core glass zone 2 the doping agent concentration stated above. Subsequently, the supply of GeCl₄ is discontinued and the same procedure used again to deposit first cladding glass layer 3 on core glass zone 2. The porous quartz glass tube obtained after removing the mandrel is then dried in a chlorine-containing atmosphere, followed by processes of sintering and collapsing to form a core rod under retention of the diameter ratio, “d_{M1}”/“d_{K}”, at its previous value of 1.99. The OH content of the core rod of 0.004 wt-ppm is homogeneous across the core rod's radial cross-section. Manufacture of the core-rod requires great care to be exercised with respect to the purity and homogeneity of the deposited layers, and thus is very resource-intensive and expensive to perform.

Simultaneously, a cladding tube is manufactured through flame hydrolysis of SiCl₄ to generate SiO₂ particles and axial deposition of the generated SiO₂ particles on a rotating mandrel. Since the cladding tube does not make a major contribution to the light transmission of the fiber made from the preform, the purity and homogeneity requirements to be met by this material are comparatively low. Thus, the cladding tube can be manufactured inexpensively by the simultaneous use of several deposition burners. Prior to sintering, the porous quartz glass cladding tube containing no doping agent is dried in a chlorine-containing atmosphere. After the sintering process, the inner and outer diameters of the cladding tube are approx. 15 mm and approx. 27 mm, respectively, and the mean OH content of 0.05 wt-ppm is homogeneous across the cross-section of the wall of the cladding tube.

It is an essential step of the procedure according to the invention that the cladding tube is collapsed onto the core rod. For this purpose, the core rod is positioned in a coaxial arrangement within the cladding tube. The surfaces facing the annular gap between core rod and cladding tube are cleaned and dehydrated by exposure to a chlorine-containing atmosphere at a temperature of approx. 1,000° C. Subsequently, the cladding tube is attached to the core rod in a melting process by heating the assembly to a temperature of 2,150° C. (furnace temperature) in an electric furnace. The annular gap is easy to close by progressive heating of the vertically arranged assembly. Once collapsed onto the core rod, the cladding tube forms second cladding glass layer 4. The interface between first cladding glass layer 3 and second cladding glass layer 4 is barely detectable with the unaided eye. There is no substantial increase of OH concentration over 0.1 wt-ppm at this interface detectable.

The quartz glass tube thus produced forms the light transmitting core of the finished optical fiber as well as the envelope contributing to light transmission (the so-called “optical cladding”). It comprises core glass zone 2, homogeneously doped with germanium dioxide, with an outer diameter of 7 mm and refractive index, “n_{K}”, which is approx. 0.005 units higher than the refractive index of quartz glass containing no doping agent. Core glass zone 2 is surrounded by a cladding of non-doped quartz glass with a refractive index, “n_{M1}”, typically being 1.4585. The cladding is formed by first cladding glass layer 3 and second cladding glass layer 4, the latter accounting for the larger part of the volume of the cladding.

To finish the manufacture of the preform, the quartz glass tube thus generated is surrounded with a quartz glass tube containing no doping agent (the so-called “cladding tube”) forming jacket glass layer 5. At this point, the outer diameter of the preform is 100 mm. The optical fiber drawn from this preform shows an optical attenuation of 0.6 dB/km at a wavelength of 1385 nm.

FIG. 4 shows a schematic depiction of a typical OH concentration profile across the diameter of a preform according to the invention. The profile of the OH concentration from FIG. 3 is shown as a dotted line for comparative purposes.

The OH concentration and preform diameter are plotted along the y- and x-axis of the diagram, respectively. The OH content of core glass layer 41 and first cladding glass layer 42 is homogeneous and low: in the embodiment referred to above it is 0.004 wt-ppm. Since the OH content of second cladding glass layer 43 is somewhat higher (0.05 wt-ppm), interface 45 between first cladding glass layer 42 and second cladding glass layer 43 is noticeable as a small step, 44, in the OH concentration profile. A pronounced peak of OH concentration, as is characteristic of state-of-the-art preforms (and therefore is present in the finished fiber), is not observed in the preform according to the invention. Consequently, interface 45 can be positioned close to core glass layer 41 without any detrimental effect on the optical attenuation of the fiber made from the preform. In other words: outer diameter “d_{M1}” of first cladding glass layer 42 is relatively small compared to the preform according to FIG. 3; outer diameter “d_{M1}” of first cladding glass layer 42 in FIG. 4 is only 1.99 times larger than diameter “d_{K}” of core glass layer 41. Thus it is feasible to reduce the volume fraction contributed to the preform by inner cladding glass layer 42, which is resource-intensive to manufacture, without any detrimental effect in terms of increased optical attenuation.

For more information on the procedures and devices for manufacture of synthetic quartz glass for optical fibers by OVD deposition with some import to the present invention, please refer to the following publications: U.S. Pat. No. 5,788,730 describes a procedure and a quartz glass deposition burner with a central nozzle and at least three annular gap nozzles for the manufacture of a soot body with homogeneous radial density distribution; DE-A1 197 25 955 describes the use of a burner for supplying liquid glass production starting materials; and DE A1 195 01 733 discloses a device for simultaneous and homogeneous gas supply to a multitude of deposition burners through the use of a pressure compensation vessel. DE-A1 196 29 170 proposes to use an electrostatic field between deposition burner and soot body in order to increase the efficiency of soot deposition; DE-A1 196 28 958 and DE-A1 198 27 945 describe measures for achievement of a more homogeneous soot deposition through the use of a burner array moved in an oscillating movement. Procedures and devices for soot body handling during and after the deposition process are known from DE-A1 197 51 919 and DE-A1 196 49 935; and U.S. Pat. No. 5,665,132, U.S. Pat. No. 5,738,702, and DE-A1 197 36 949 describe holding measures for the soot body during vitrification. Quartz glass doping with fluorine and boron is described in EP-A 582 070; U.S. Pat. No. 5,790,736 discloses a method for adjustment of the viscosity of fiber core and jacket materials. DE 198 52 704 illustrates a procedure for manufacture of an optical fiber from doped substrate tubes using the MCVD method. Post-treatment of a vitrified quartz glass hollow cylinder with a specialized drill is disclosed in U.S. Pat. No. 5,643,069. U.S. Pat. No. 5,785,729 describes the manufacture of large-volume preforms with the rod-in-tube technique; and DE-A1 199 15 509 describes a suitable exhaust for the latter technique. EP-A1 767 149 and DE-A1 196 29 169 both are concerned with the manufacture of quartz glass tubes with high dimensional accuracy through a vertical drawing procedure.

1. A method for the manufacture of an optical fiber by drawing from a preform with a core-clad structure or from a coaxial arrangement of several components forming a core-clad structure, in which a core cylinder is produced with a soot deposition method with the core cylinder having a core glass layer of a higher refractive index “n_{K}” and outer diameter “d_{K}”, which is surrounded by a first cladding glass layer of a lower refractive index “n_{M1}” and outer diameter “d_{M1}”, and a second cladding glass layer is applied onto the core cylinder, whereby the second cladding glass layer is provided in the form of a cladding tube produced in a separate step of the procedure, the cladding tube having a mean OH concentration of max. 1 wt-ppm, with the second cladding glass layer being applied by collapsing the cladding tube onto the core cylinder (2; 3), and that a core cylinder (2; 3) with a ratio of “d_{M1}” to “d_{K}” between 1 and 2.2 is used, and the core cylinder having a mean OH concentration of max. 1 wt-ppm in an area near the surface up to a depth of 10 μm, characterized in that the core cylinder (2; 3) is manufactured according to the outside vapor deposition method (OVD method), and that the second cladding glass layer (4) is produced with the ratio of outer diameter to inner diameter being between 1.8 and 3 and that the second cladding glass layer (4) is surrounded by at least one additional, third cladding glass layer (5).

2. A method according to claim 1, characterized in that a cladding tube with a mean OH concentration of max. 0.5 wt-ppm and a core cylinder (2; 3) with a mean OH concentration of max. 0.5 wt-ppm in an area near the surface up to a depth of 10 μm are used.

3. A method according to claim 1, characterized in that a cladding tube with a mean OH concentration of max. 0.2 wt-ppm and a core cylinder (2; 3) with a mean OH concentration of max. 0.2 wt-ppm in an area near the surface up to a depth of 10 μm are used.

4. A method according to claim 1, characterized in that a cladding tube with a mean OH concentration of max. 0.1 wt-ppm and a core cylinder (2; 3) with a mean OH concentration of max. 0.1 wt-ppm in an area near the surface up to a depth of 10 μm are used.

5. A method according to any one of the preceding claims, characterized in that a core cylinder (2; 3) is used with the ratio of “d_{M1}” to “d_{K}” being smaller than 2.0.

6. A method according to any one of the preceding claims, characterized in that a core cylinder (2; 3) is used with the ratio of “d_{M1}” to “d_{K}” being smaller than 1.7.

7. A method according to any one of the preceding claims, characterized in that a quartz glass cladding tube is used.

8. A method according to any one of the claims 1 to 6, characterized in that a SiO₂ soot cladding tube is used.

9. A method according to any one of the preceding claims, characterized in that a cladding tube with a refractive index “n_{M2}”, with “n_{M2}” being ≦“n_{M1}” is used.

10. A method according to any one of the preceding claims, characterized in that a cladding tube of fluoride-doped quartz glass is used.

11. A method according to claim 1, characterized in that the third cladding glass layer (5) is provided in the form of a quartz glass hollow cylinder which is collapsed, together with the cladding tube, onto the core cylinder (2; 3).

12. A method according to claim 1, characterized in that the third cladding glass layer (5) is provided in the form of a hollow cylinder of porous SiO₂ soot which, after collapsing, is being shrunk onto the second cladding glass layer (4) enveloping the core cylinder (2; 3).

13. A method according to claim 1, characterized in that the third cladding glass layer (5) is produced by outside deposition of SiO₂ soot after collapsing of the cladding tube onto the core cylinder (2; 3).

14. A method according to claim 1, characterized in that the second cladding glass layer (4) and the third cladding glass layer (5) are produced by providing a cladding tube, coated on the outside with porous SiO₂ soot, the cladding tube being collapsed onto the core cylinder (2; 3).

15. A method according to any one of the preceding claims, characterized in that collapsing comprises a coaxial arrangement of cladding tube and core cylinder (2; 3) by formation of an annular gap and that hydrogen-containing substances are excluded from the annular gap during the collapsing process.

16. A method according to claim 15, characterized in that negative pressure is established in the annular gap and/or that the annular gap contains helium, chlorine, fluorine or a mixture of these gases.
